(19) United States
(12) Patent Application Publication
(10) Pub. No.: US 2025/0026623 A1
(43) Pub. Date: Jan. 23, 2025

(54) Tabbed Lid Opening Hand, Tabbed Lid Opening System, And Method Of Opening Tabbed Lid

(71) Applicant: SEIKO EPSON CORPORATION, Tokyo (JP)

(72) Inventors: Yuki YAHIRO, Matsumoto (JP); Tsubasa MATSUSHITA, Azumino (JP)

(21) Appl. No.: 18/777,963

(22) Filed: Jul. 19, 2024

(30) Foreign Application Priority Data
Jul. 20, 2023 (JP) 2023-118633

(51) Int. Cl. B67B 7/40; B25J 15/00; B67B 7/16

(52) U.S. Cl. CPC B67B 7/403; B25J 15/0028; B67B 7/162; B67B 7/164

(57) ABSTRACT

A tabbed lid opening hand for use in an opening lid operation for removing a tabbed lid, which has a lid main body that closes a circular shaped opening section of a container and a tab that is connected to the lid main body and that is disposed along the outer side surface of the container, from the opening section, the tabbed lid opening hand includes a base section that is attached to a robot arm; two claw sections that are supported by the base section and that approach and separate from each other; and a hook that is disposed with its tip end section facing in a direction intersecting the approach and separation directions and that is configured to engage with the tab.

The present application is based on, and claims priority from JP Application Serial Number 2023-118633, filed Jul. 20, 2023, the disclosure of which is hereby incorporated by reference herein in its entirety.

### BACKGROUND

### 1. Technical Field

The present disclosure relates to a tabbed lid opening hand, a tabbed lid opening system, and a method of opening a tabbed lid.

### 2. Related Art

Amongst wide-mouth containers for beverage packaging, there is a container that has a lid plate with a pull tab that seals the bottle mouth.

For example, JP-A-2003-170953 discloses a lid plate that is made of aluminum or the like for sealing the bottle mouth of a wide-mouth container, and a pull tab that is provided on the lid plate. The lid plate is crimped onto the bottle mouth and slightly enters inside of the bottle mouth. By this, a sealed condition is secured. Such a lid plate is removed from the bottle mouth by pulling up the pull tab. By this, the bottle mouth can be opened.

In recent years, automation of work has been studied by introducing robots that replace the work of operators. As one of them, automation of work for opening a lid of a container has been studied. Since the lid plate described in JP-A-2003-170953 is opened by pulling up the pull tab, an opening hand with a function to gripe the pull tab is required for automation.

The tab is usually disposed so as to stick along the outer side surface of the bottle mouth. Therefore, the tabbed lid cannot be held by the opening hand, and there is a problem that it is difficult to automate the opening lid operation of the tabbed lid.

### SUMMARY

A tabbed lid opening hand according to an application example of the present disclosure is a tabbed lid opening hand for use in an opening lid operation for removing a tabbed lid, which has a lid main body that closes a circular shaped opening section of a container and a tab that is connected to the lid main body and that is disposed along the outer side surface of the container, from the opening section, a base section that is attached to a robot arm; two claw sections that are supported by the base section and that approach and separate from each other; and a hook that is disposed with its tip end section facing in a direction intersecting the approach and separation directions and that is configured to engage with the tab.

A tabbed lid opening system according to an application example of the present disclosure includes a robot with a robot arm, and a tabbed lid opening hand according to the application example of the present disclosure, which is attached to the robot arm.

A method of opening a tabbed lid according to an application example of the present disclosure is a method for removing a tabbed lid, which has a lid main body that closes a circular shaped opening section of a container and a tab that is connected to the lid main body and that is disposed along an outer side surface of the container, from the opening section by a automatic machine, and the automatic machine having a claw section, a tab holding section, and a robot arm that moves the tab holding section relative to the container, extending a distance between the container and the tab by inserting the claw section between the container and the tab along a tangential direction, assuming that the tangential direction is a direction parallel to a tangential line of the outer edge of the opening section; holding the tab by the tab holding section; and removing the tabbed lid from the container by the robot arm by moving the tab holding section, which is holding the tab, relative to the container.

### BRIEF DESCRIPTION OF THE DRAWINGS

FIG. 1 is a schematic diagram showing a tabbed lid opening system according to a first embodiment.

FIG. 2 is a partial cross-sectional view of a lidded container in FIG. 1.

FIG. 3 is an enlarged view of the tabbed lid opening hand shown in FIG. 1.

FIG. 4 is a front view of the tabbed lid opening hand shown in FIG. 3 as viewed from the Y-axis plus direction.

FIG. 5 is an enlarged perspective view of the tabbed lid opening hand shown in FIG. 3.

FIG. 6 is a partially enlarged view of a claw section shown in FIG. 5.

FIG. 7 is a functional block diagram of the tabbed lid opening system shown in FIG. 1.

FIG. 8 is a diagram showing a hardware configuration example of the control device in FIG. 7.

FIG. 9 is a flowchart showing a process of the method of opening a tabbed lid according to the first embodiment.

FIG. 10 is a schematic view showing a positional relationship between the claw section, a hook, and the tab in a claw section insertion step.

FIG. 11 is another schematic view showing a positional relationship between the claw section, the hook, and the tab in the claw section insertion step.

FIG. 12 is still another schematic view showing a positional relationship between the claw section, the hook, and the tab in the claw section insertion step.

FIG. 13 is a schematic diagram showing a positional relationship between the hook and the tab in a tab holding step.

FIG. 14 is another schematic view showing a positional relationship between the hook and the tab in the tab holding step.

FIG. 15 is a schematic view showing a positional relationship between the hook and the tab in a removal step.

FIG. 16 is another schematic view showing a positional relationship between the hook and the tab in the removal step.

FIG. 17 is still another schematic view showing a positional relationship between the hook and the tab in the removal step.

FIG. 18 is further another schematic view showing a positional relationship between the hook and the tab in the removal step.

FIG. 19 is a schematic view showing the tabbed lid opening hand according to a first modification of the first embodiment.

FIG. 20 is a schematic view for explaining the method of opening the tabbed lid according to a second embodiment.

FIG. 21 is another schematic view for explaining the method of opening the tabbed lid according to the second embodiment.

FIG. 22 is a schematic view for explaining the method of opening the tabbed lid according to the second embodiment.

FIG. 23 is a schematic view for explaining a method of opening a tabbed lid according to a third embodiment.

### DESCRIPTION OF EMBODIMENTS

Hereinafter, a tabbed lid opening hand, a tabbed lid opening system, and a method of opening the tabbed lid of the present disclosure will be described in detail based on an embodiment shown in the accompanying drawings.

### 1. First Embodiment

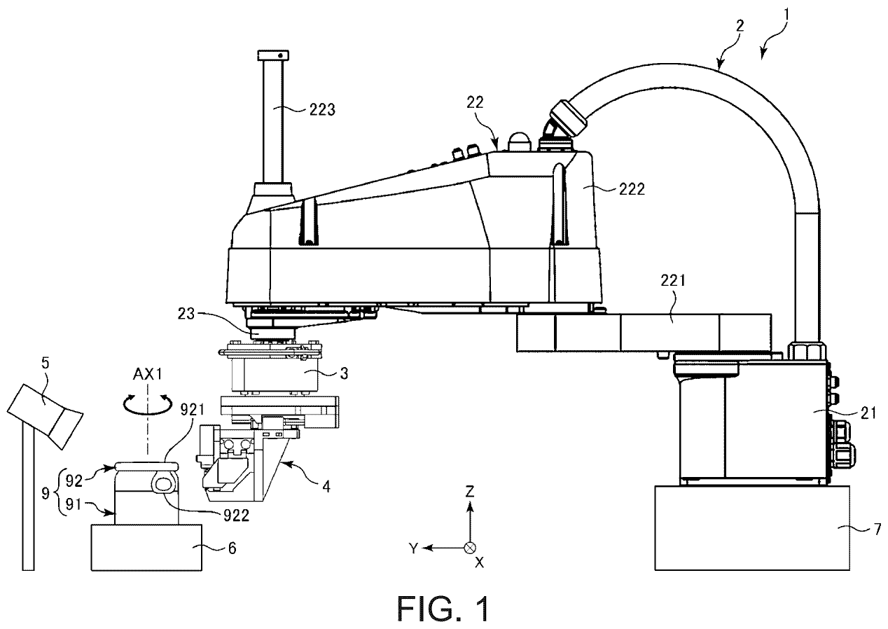

First, a tabbed lid opening hand and a tabbed lid opening system according to a first embodiment will be described. FIG. 1 is a schematic view showing a tabbed lid opening system 1 according to the first embodiment.

In each drawing of the present application, an X-axis, a Y-axis, and a Z-axis are set as three axes orthogonal to each other. Each axis is represented by an arrow, and a tip end side of the arrow is “plus” and a base side of the arrow is “minus”. In the following description, for example, the “X-axis direction” includes both the plus direction and the minus direction of the X-axis. The same applies to the Y-axis direction and the Z-axis direction. In the following description, in particular, the Z-axis plus side is also referred to as “upper”, and the Z-axis minus side is also referred to as “lower”.

### 1.1. Overview of the Tabbed Lid Opening System

The tabbed lid opening system 1 shown in FIG. 1 is equipped with a robot 2, a force sensor 3, a tabbed lid opening hand 4 (the tabbed lid opening hand according to the first embodiment), a camera 5, a pivot mechanism 6, and a control device 7.

The robot 2 has a base 21 and a robot arm 22. The force sensor 3 and the tabbed lid opening hand 4 are attached to the robot arm 22. The tabbed lid opening hand 4 is used for an opening lid operation to remove a tabbed lid 92 from the lidded container 9, which is constituted by a container 91 and the tabbed lid 92 as shown in FIG. 1. Specifically, the tabbed lid 92 has a lid main body 921 and a tab 922, as shown in FIG. 1. The tabbed lid opening hand 4 approaches the lidded container 9 by changing a posture of the robot arm 22, and lifts up and holds the tab 922. Then, by changing the posture of the robot arm 22 in this state, the tabbed lid 92 is removed from the container 91.

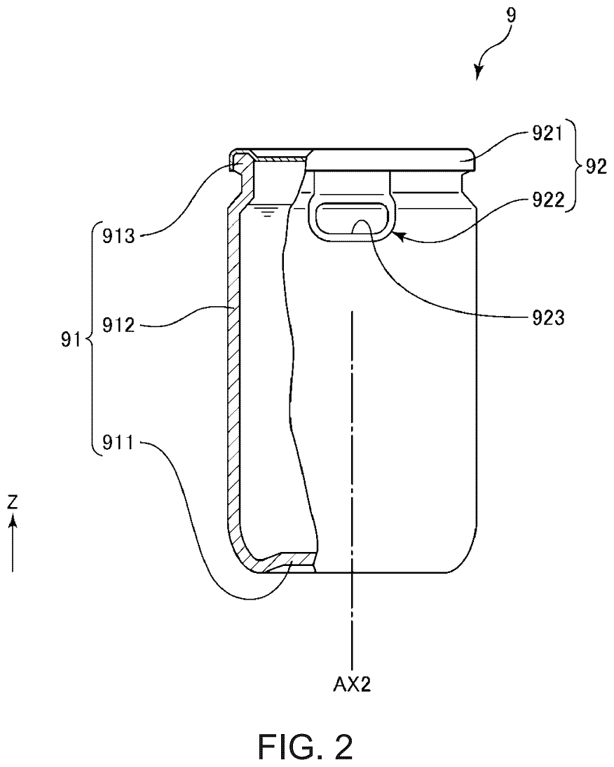

FIG. 2 is a partial cross-sectional view showing the lidded container 9 in FIG. 1. The container 91 shown in FIG. 2 has a bottom section 911, a wall section 912, and an opening section 913. The central axis of the container 91 is defined as AX2. The bottom section 911 has a disk shape that extends along a plane orthogonal to the central axis AX2. The wall section 912 stands from the outer edge of the bottom section 911 along the central axis AX2, and has a cylindrical shape. The opening section 913 is connected to an upper end portion of the wall section 912 and has a circular shape. Note that the shape of the container 91 is not limited to this. For example, a shape of the bottom section 911 may be an elliptical shape or an oval shape, or may be a polygonal shape such as a hexagonal shape or an octagonal shape, or may be any other shape. A shape of the wall section 912 may be a tubular shape other than a cylindrical shape, for example, a tubular shape with a polygonal shape cross section.

The tabbed lid 92 shown in FIG. 2 has the lid main body 921 and the tab 922. The lid main body 921 is, for example, crimped to the opening section 913, and closes the opening section 913. The tab 922 is connected to the lid main body 921, and is disposed along an outer surface of the wall section 912 (container 91). Specifically, the tab 922 is connected to an outer peripheral surface of the lid main body 921. The tab 922 is a tongue-shaped portion extending downward from the connecting portion of the lid main body 921 so that it is along the outer surface of the wall section 912. The tab 922 shown in FIG. 2 has a through hole 923 penetrating in a thickness direction. In such a tabbed lid 92, when the tab 922 is pulled upward (the Z-axis plus direction), the connection section between the tab 922 and the tabbed lid main body 921 fractures and the tabbed lid main body 921 loosens. Then, by moving the tab 922 in a direction intersecting the Z-axis so that it passes above the container 91, the lid main body 921 is separated from the opening section 913. The shape of the tabbed lid 92 is not limited to this. For example, the tab 922 may not have the through hole 923.

The force sensor 3 is attached to the robot arm 22. The force sensor 3 detects force that the tabbed lid opening hand 4 receives, such as a translation force or a rotational force (moment), and outputs force detection information. The control device 7 reflects this force detection information onto the posture of the robot arm 22. Note that the force sensor 3 may be provided as necessary, and may be omitted, for example, when it is not necessary to reflect the force detection information. A compliance mechanism may be provided instead of the force sensor 3 or in addition to the force sensor 3.

The tabbed lid opening hand 4 is attached to the robot arm 22 via the force sensor 3. The tabbed lid opening hand 4 is used for opening lid operation to remove the tabbed lid 92 from the container 91 of the lidded container 9. The lidded container 9 is placed on the Y-axis plus side from the tabbed lid opening hand 4.

The camera 5 captures an image of the lidded container 9 and outputs the image. The control device 7 detects the tab 922 based on this image. The camera 5 may be provided as necessary, and may be omitted in a case where the position of the tab 922 is constant and detection is unnecessary, or in a case where detection can be performed by other sensors. The other sensors include, for example, a displacement sensor such as a laser displacement meter, a contact detection sensor such as a contact detection probe, and the like. The camera 5 shown in FIG. 1 is fixed to the floor surface on which the robot 2 is placed. However, the camera 5 may be fixed to a wall surface or a ceiling surface of a room in which the robot 2 is placed, or may be attached to the robot arm 22.

The pivot mechanism 6 supports the lidded container 9 and pivots the lidded container 9 around the pivot axis AX1. The pivot axis AX1 is set so as to overlap the central axis AX2 of the container 91. By pivoting the lidded container 9, the position of the tab 922 is changed in the circumferential direction around the pivot axis AX1, and the tab 922 can be positioned within the workable region of the tabbed lid opening hand 4. Note that the pivot mechanism 6 may be omitted if the tab 922 can be positioned within the workable region of the tabbed lid opening hand 4 by other means, for example, in a case where the tab 922 can be positioned within the workable region by changing the posture of the robot arm 22 and by moving the tabbed lid opening hand 4.

The control device 7 obtains the force detection information that is output from the force sensor 3 and the image that is output from the camera 5. The control device 7 also controls each operation of the robot 2, the tabbed lid opening hand 4, and the pivot mechanism 6. Further, it reflects the force detection information and the image to these controls.

### 1.2. Robot

The robot 2 shown in FIG. 1 is a horizontal articulated robot having the base 21 and the robot arm 22. Note that a form of the robot 2 is not limited to this, and may be a vertically articulated robot, a Cartesian coordinate robot using a slider mechanism, or a dual-arm robot having a plurality of robot arms 22.

The base 21 supports the robot arm 22. The robot arm 22 has a tip end section 23 to which various end effectors can be attached. The tabbed lid opening hand 4 is attached to the tip end section 23 shown in FIG. 1 via the force sensor 3. The robot arm 22 moves the tabbed lid opening hand 4 to an arbitrary position in the space.

The robot arm 22 has a first arm 221, a second arm 222, and a third arm 223. The first arm 221 pivots around a pivot axis that is parallel to the Z-axis with respect to the base 21. The second arm 222 is provided at the tip end section of the first arm 221, and pivots around a pivot axis that is parallel to the Z-axis. The third arm 223 has a rod-like shape extending parallel to the Z-axis, and can translate along the Z-axis and pivot around a pivot axis parallel to the Z-axis.

### 1.3. Tabbed Lid Opening Hand

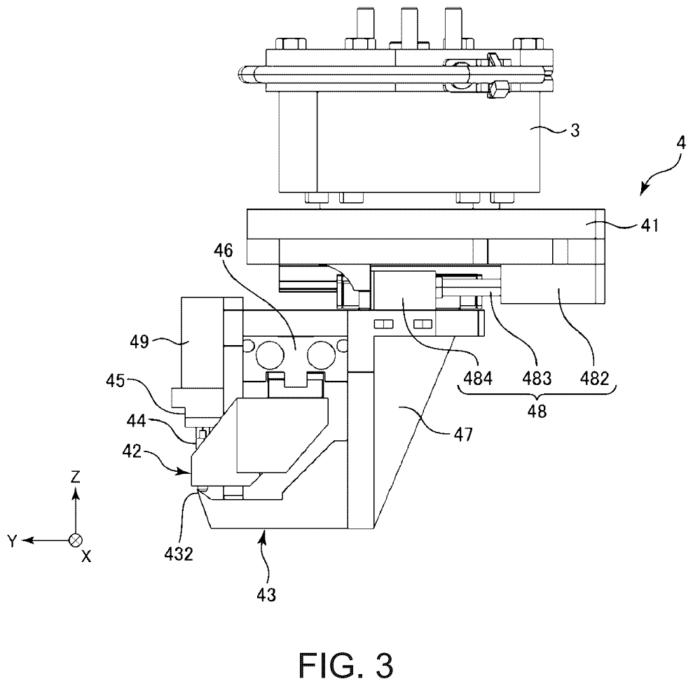

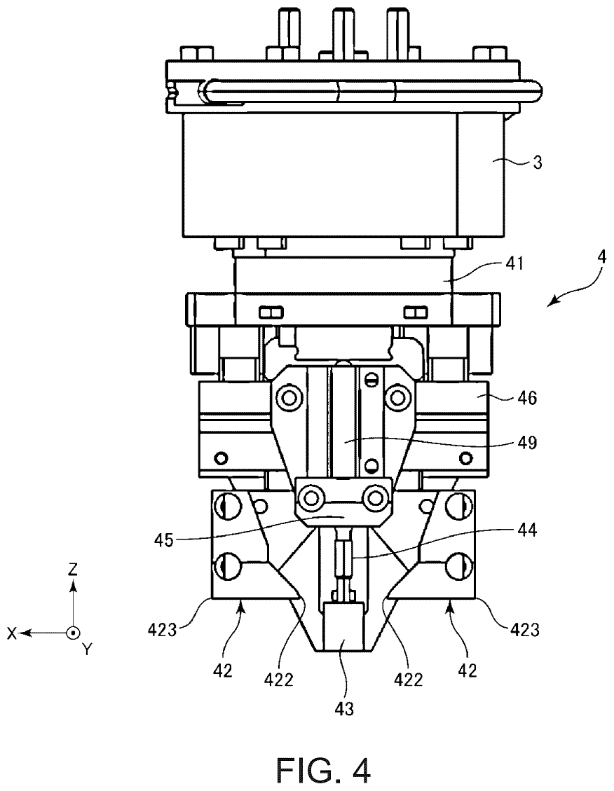

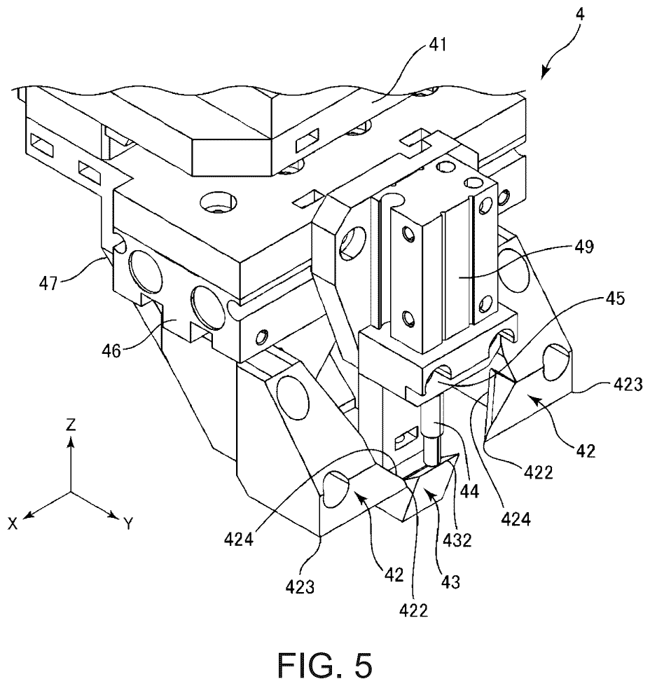

FIG. 3 is an enlarged view of the tabbed lid opening hand 4 shown in FIG. 1. FIG. 4 is a front view of the tabbed lid opening hand 4 shown in FIG. 3 as viewed from the Y-axis plus direction. FIG. 5 is an enlarged perspective view of the tabbed lid opening hand 4 shown in FIG. 3.

The tabbed lid opening hand 4 shown in FIGS. 3 to 5 has a base section 41, two claw sections 42, 42, a hook 43, a disengagement prevention section 44, a pressing section 45, a claw opening and closing section 46, a support section 47, a slide section 48, and a disengagement prevention drive section 49.

The base section 41 is attached to the robot arm 22 via the force sensor 3. Each section other than the base section 41 is directly or indirectly attached to the base section 41.

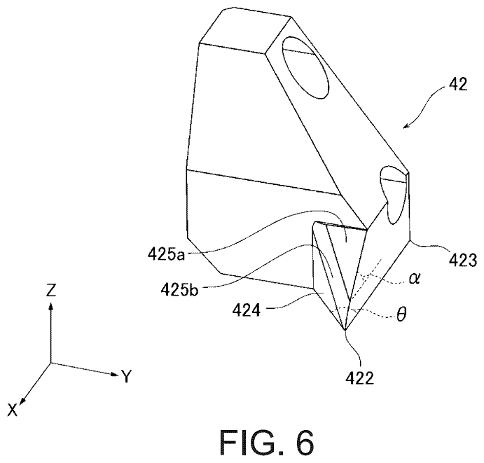

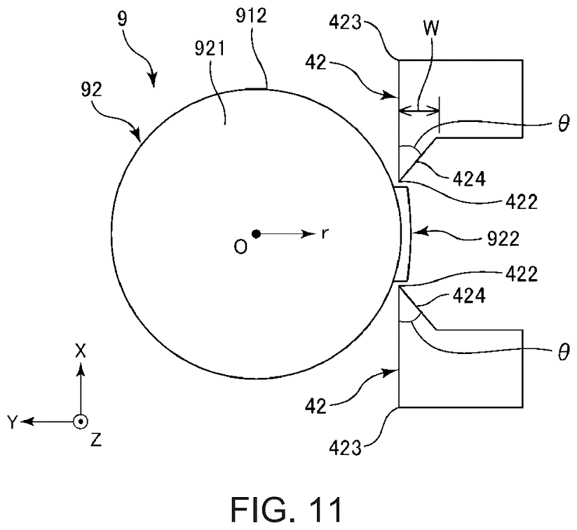

As shown in FIG. 5, the two claw sections 42, 42 are arranged side by side in the X-axis direction via a gap. The shapes of the two claw sections 42, 42 may be different from each other, but are the same in FIG. 5. Each claw section 42 has a claw tip end section 422, a base end section 423, and an inclined surface 424. The claw sections 42 face each other across the aforementioned gap. The inclined surface 424 has a substantially triangular shape including the claw tip end section 422 as one of its vertices. The inclined surface 424 shown in FIG. 5 is a substantially flat surface inclined with respect to both the X-axis and the Y-axis. Specifically, when a normal line is drawn on the inclined surface 424, this normal line obliquely intersects at least the X-axis and the Y-axis. The angle formed by the inclined surface 424 and the X-Z plane is represented by an angle θ in FIGS. 6 and 11 (to be described later), and this angle θ is an acute angle. The claw sections 42 have a function of separating the tab 922, which extends along the outer side surface of the wall section 912, from the wall section 912 in the opening lid operation. Two claw sections 42, 42 are driven by the claw opening and closing section 46 (to be described later) so as to approach and separate from each other along an opening and closing axis that is parallel to the X-axis. The opening lid operation will be described later. The shape of the claw sections 42, 42 is not limited to this. For example, the inclined surface 424 shown in FIG. 5 is substantially parallel to the Z-axis, but it may be inclined with respect to the Z-axis.

FIG. 6 is a partially enlarged view of the claw section 42 shown in FIG. 5. The claw section 42 shown in FIG. 6 has an upper surface 425a and a curved surface 425b in addition to the inclined surface 424 described above. The upper surface 425a is a substantially flat surface inclined with respect to both of the X-axis and the Z-axis. The angle formed by the upper surface 425a and the X-Y plane is represented by an angle α in FIG. 6, and this angle α is an acute angle. The inclined surface 424 described above has a function of separating the tab 922 from the wall section 912, whereas the upper surface 425a has a function of pushing up the tab 922 that was separated from the wall section 912, from below. By this, it is possible to secure a wider space into which the hook 43 (to be described later) can enter. The curved surface 425b is provided between the inclined surface 424 and the upper surface 425a, and is a curved surface that smoothly connects these surfaces. As will be described in detail later, in the opening lid operation, first, the inclined surface 424 comes into contact with the tab 922, and then the upper surface 425a comes into contact with the tab 922. The curved surface 425b has a function of facilitating transition by contacting the tab 922 in a process of this transition. By providing the curved surface 425b, it is possible to suppress the occurrence of snagging or the like in the transition process, thus the opening lid operation can be performed more smoothly.

Each surface of the claw section 42 has been described above, but the shape of the claw section 42 is not limited to the above. For example, the upper surface 425a and the curved surface 425b may be omitted, or other surfaces may be provided.

As shown in FIG. 3, the hook 43 extends along the Y-axis and has a hooked shape whose upper surface is gradually displaced upward toward the Y-axis plus side (tip end). The hook 43 has a function of engaging with the lower surface of the tab 922 from below the tab 922 and lifting up the tab 922 in accordance with posture change of the robot arm 22. In other words, the hook 43 contacts at least the lower surface of the tab 922, and serves as a fulcrum in lifting up (pull up) the tab 922. If the tab 922 has the through hole 923, the tip end of the hook 43 may be inserted into the through hole 923. The hook 43 has a tip end section 432 that protrudes obliquely upward. The tip end section 432 has a shape that can be easily inserted into the through hole 923, for example, a shape in which the length in the Y-axis direction gradually decreases or a shape in which the thickness in the Z-axis direction gradually decreases toward the tip end. Therefore, by inserting the hook 43 into the through hole 923, the hook 43 can be more stably engaged with the tab 922. The shape of the hook 43 is not limited to this. For example, the shape of the hook 43 may be, instead of the hooked shape described above, a shape having a groove in which a part of the tab 922 fits, a shape having a protrusion on which the tab 922 is hooked, or the like.

The hook 43 is configured so that the tip end section 432 faces in a direction along the intersecting axis that intersects the opening and closing axis described above. In this embodiment, the opening and closing axis is a part of the X-axis, that is, a part of between the claw sections 42 in the X-axis, and the intersecting axis intersects this opening and closing axis. Specifically, the hook 43 is located below an intermediate point between the claw sections 42, and the tip end section 432 faces obliquely upward so as to approach the lidded container 9. By this, when the claw sections 42 are inserted so as to separate the tab 922 from the wall section 912, the hook 43 is located immediately below (in the vicinity of) the claw sections 42, and the tip end section 432 faces toward the tab 922. As a result, it is possible to smoothly engage the hook 43 with the lower surface of the tab 922 according to the posture change of the robot arm 22. With such an arrangement, interference between the claw sections 42 and the tab 922 being picked up by the hook 43 can be avoided by opening the claw sections 42.

Note that the hook 43 may be located obliquely below or may be above the claw sections 42, rather than directly below the intermediate point between the claw 42. However, considering that operations to engage with the lower surface of the tab 922 and to lift it up are necessary, it is desirable that the hook 43 be located downward of the tab 922.

As shown in FIGS. 4 and 5, the disengagement prevention section 44 is disposed above the hook 43, and has a pin shape that extends along the Z-axis. The disengagement prevention section 44 is driven by the disengagement prevention drive section 49 (to be described later), and approaches and separates from the hook 43 by being displaced up and down.

As shown in FIGS. 3 to 5, the pressing section 45 is constituted by a surface intersecting the Y-axis. The pressing section 45 has a function of maintaining a distance between the claw sections 42, 42 and the container 91 at a constant distance by being pressed against the outer peripheral surface of the lid main body 921 of the tabbed lid 92. In other words, by pressing the pressing section 45 against the lid main body 921, the distance between the claw sections 42, 42 and the container 91 can be easily controlled to a target distance without bringing the claw sections 42, 42 into contact with the container 91. By this, it is possible to further increase the success rate of opening lid operation (to be described later).

The claw opening and closing section 46 extends in the X-axis direction and translationally drives the two claw sections 42, 42 so that they can approach and separate from each other. By this, the claw sections 42 can be driven to open and close at a desired timing. Two claw sections 42, 42 open and close along the outside surface of the wall section 912 and in a tangential direction. Tangential direction refers to a direction parallel to the tangential line of the outer edge of the circular shaped opening section 913. The claw opening and closing section 46 includes, for example, a drive section used for an air chuck, an electric chuck, and the like.

The support section 47 supports the hook 43, the claw opening and closing section 46, the disengagement prevention drive section 49, and the like. The support section 47 is attached to the base section 41 via the slide section 48.

As shown in FIG. 3, the slide section 48 has a fixed section 482, a rod 483, and a movable section 484. The fixed section 482 is fixed to the base section 41, and the support section 47 is connected to the movable section 484. The rod 483 extends in the Y-axis direction. The fixed section 482 is connected to a Y-axis minus end portion of the rod 483, and the movable section 484 is connected to a Y-axis plus end portion of the rod 483. A coil spring (not shown) is built into the fixed section 482. For example, when the pressing section 45 is pressed against the lid main body 921, a reaction force generated corresponding to the pressing force is transmitted to the movable section 484 through the support section 47. The reaction force transmitted to the movable section 484 contracts the coil spring through the rod 483. By this, the distance between the fixed section 482 and the movable section 484 can be reduced. As a result, the pressing force can be reduced, and the pressing force can be prevented from becoming excessive.

The disengagement prevention drive section 49 translationally drives the disengagement prevention section 44, which extends in the Z-axis direction, so as to approach and separate from the hook 43. By this, it is possible to drive the disengagement prevention section 44 at a desired timing. The disengagement prevention drive section 49 includes, for example, an air cylinder, a ball screw actuator, an electric actuator, and the like. The disengagement prevention drive section 49 may use a spring or the like, without using air pressure, electricity or the like. A structure to realize such a disengagement prevention drive section 49 is, for example, such that when the disengagement prevention section 44 and the tab 922 are in contact, the disengagement prevention section 44 is displaced using that force.

### 1.4. Control Device

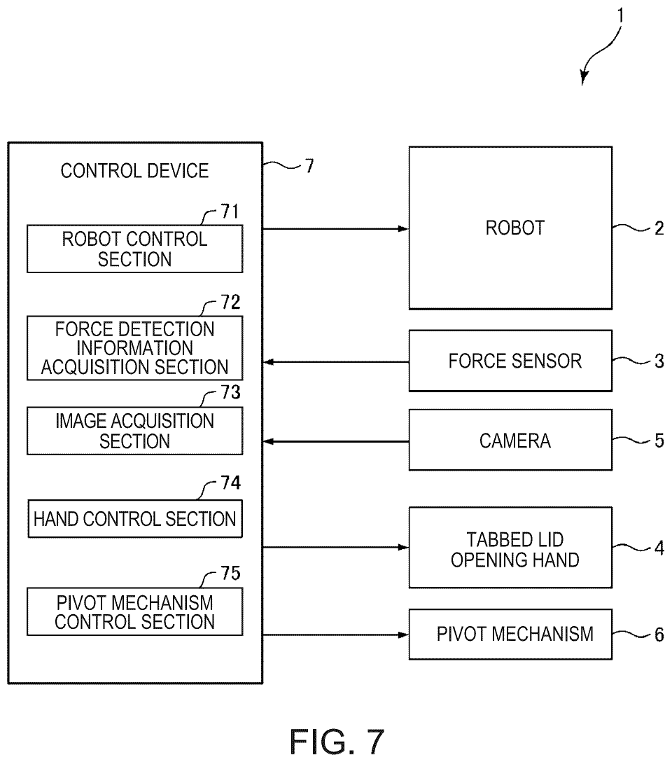

FIG. 7 is a functional block diagram of the tabbed lid opening system 1 shown in FIG. 1.

As shown in FIG. 7, the control device 7 includes, as functional sections, a robot control section 71, a force detection information acquisition section 72, an image acquisition section 73, a hand control section 74, and a pivot mechanism control section 75.

The robot control section 71 controls operations of the robot arm 22 and has a function of moving the tabbed lid opening hand 4 in accordance with the lidded container 9.

The force detection information acquisition section 72 acquires the force detection information output from the force sensor 3. If necessary, the force detection information is reflected in a control of the operation of the robot arm 22 by the robot control section 71, and a control of the operation of the tabbed lid opening hand 4 by the hand control section 74.

The image acquisition section 73 acquires an image output from the camera 5. If necessary, the image is reflected in the control of the operation of the robot arm 22 by the robot control section 71, the control of the operation of the tabbed lid opening hand 4 by the hand control section 74, and a control of the operation of the pivot mechanism control section 75.

The hand control section 74 controls the operation of the tabbed lid opening hand 4. Specifically, it controls operations of the claw opening and closing section 46 and the disengagement prevention drive section 49.

The pivot mechanism control section 75 controls the operation of the pivot mechanism 6. Specifically, for example, it detects the position of the tab 922 in the circumferential direction around the pivot axis AX1 based on the image acquired by the image acquisition section 73. Then, it determines operation conditions of the pivot mechanism 6 according to the position of the tab 922, and pivots the lidded container 9 around the pivot axis AX1.

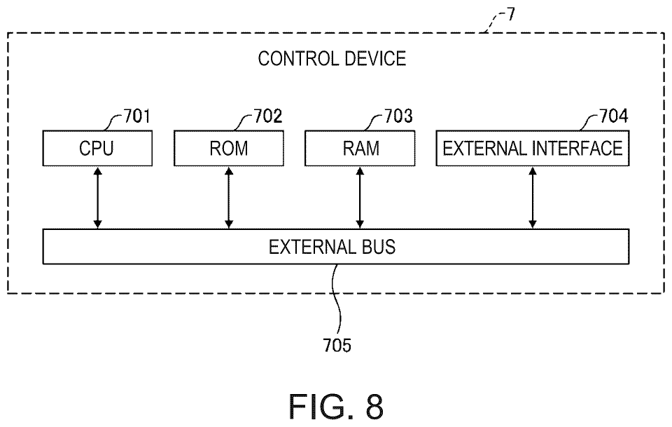

FIG. 8 is a diagram showing a hardware configuration example of the control device 7 in FIG. 7. The functions of each functional section of the control device 7 are realized, for example, by hardware with CPU 701, ROM 702, RAM 703, external interface 704, and external bus 705 shown in FIG. 8. The CPU 701, the ROM 702, the RAM 703, and the external interface 704 can communicate with each other via the external bus 705.

The CPU 701 is a Central Processing Unit. The functions of each functional section are realized by loading various programs stored in the ROM 702 into the RAM 703 and causing the CPU 701 to execute the programs. Note that the CPU 701 may be, for example, a digital signal processor (DSP). All or part of the hardware may be constituted by a field programmable gate array (FPGA), an application specific integrated circuit (ASIC), or the like.

The ROM 702 is a read only memory and is composed of an arbitrary non-volatile memory element. The RAM 703 is a random access memory and is composed of an arbitrary volatile memory element. The ROM 702 stores programs, data, setting values, and the like. These may be provided from the outside via a removable storage medium, a network, or the like. The ROM 702 and RAM 703 may be removable external storage devices, or may be storage devices located elsewhere over a network.

The external interface 704 includes, for example, digital input/output port such as universal serial bus (USB), an Ethernet (registered trademark) port, and the like. The external interface 704 is used to transmit and receive signals to and from the robot 2 and other sections.

### 1.5. Method of Opening Tabbed Lid

Next, a method of opening a tabbed lid according to the first embodiment will be described. Note that, here, a method using the tabbed lid opening system 1 (automatic machine) according to the first embodiment will be described as an example.

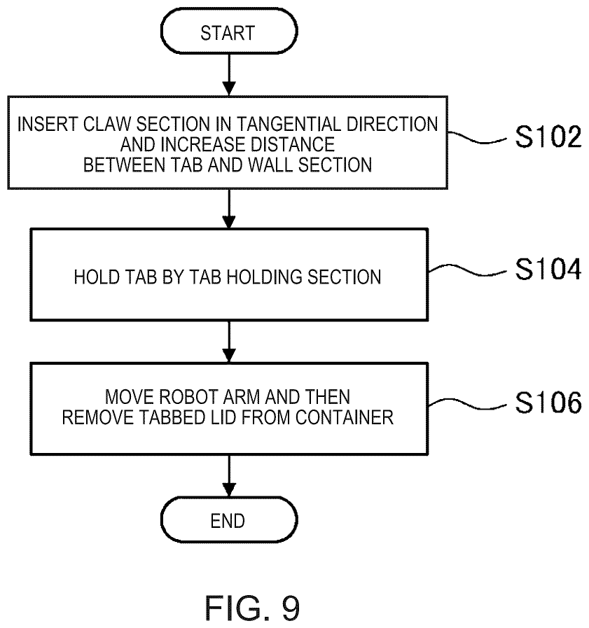

FIG. 9 is a flowchart showing a configuration of the method of opening a tabbed lid according to the first embodiment. The method of opening the tabbed lid shown in FIG. 9 includes a claw section insertion step S102, a tab holding step S104, and a removal step S106.

### 1.5.1. Claw Section Insertion Step

In the claw section insertion step S102, the claw sections 42 are inserted between the tab 922 and the wall section 912 along the tangential direction described above.

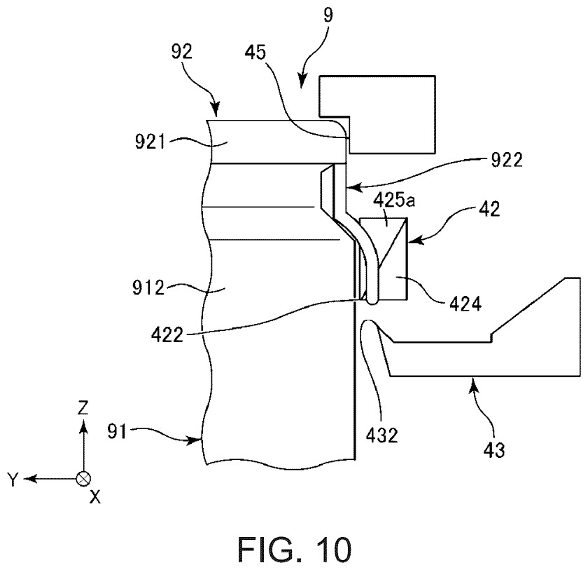

FIGS. 10 to 12 are schematic diagrams showing the positional relationship between the claw sections 42, the hook 43, and the tab 922 in the claw section insertion step S102. Note that in FIGS. 10 to 12, for convenience of illustration, only some of the elements constituting the tabbed lid opening hand 4 are shown.

In the claw section insertion step S102, first, the image acquisition section 73 operates the camera 5 to image the lidded container 9. The image acquisition section 73 acquires an image of the lidded container 9 and detects a position of the tab 922. When the position of the tab 922 is not within the workable region of the tabbed lid opening hand 4, the position of the tab 922 is output. The pivot mechanism control section 75 calculates the pivot angle of the lidded container 9 based on the position of the tab 922, and operates the pivot mechanism 6 based on the calculated angle. By this, it is possible to put the tab 922 into the workable region by pivoting the lidded container 9.

Next, the robot control section 71 changes the posture of the robot arm 22 based on the position of the tab 922, thereby bringing the tabbed lid opening hand 4 closer to the lidded container 9. As shown in FIG. 10, the pressing section 45 is pressed against the outer edge of the lid main body 921. By this, a distance between the tabbed lid opening hand 4 and the lidded container 9 can be set to a target distance. Since it is possible to avoid contact with the container 91 by pressing the pressing section 45 against the lid main body 921, it is possible to prevent the container 91 from being damaged or the like. Note that if excessive pressing force occurs when pressing the pressing section 45, it can be lessened by the slide section 48.

In FIG. 11, the center of the lid main body 921 as viewed from the Z-axis direction is represented by O, and the radial direction of the lid main body 921 is represented by r. The distance between the pressing section 45 and the claw sections 42 in the radial direction r (Y-axis direction in FIG. 11) is set in advance in accordance with the specifications of the lidded container 9. Thus, when the pressing section 45 is pressed against the lid main body 921, the claw sections 42 are located in the vicinity of a gap between the wall section 912 of the container 91 and the tab 922. The “vicinity” means, for example, as shown in FIG. 11, a position that is separated from the gap between the wall section 912 and the tab 922 in the tangential direction (X-axis direction in FIG. 11).

Next, the hand control section 74 operates the claw opening and closing section 46 to move the two claw sections 42, 42 to approach each other. By this, the two claw sections 42, 42 shown in FIG. 11 approach the tab 922, and as shown in FIG. 10, the claw tip end sections 422 of the claw sections 42 enter the gap between the wall section 912 and the tab 922. Note that since wall section 912 has a cylindrical shape, the outer surface thereof is curved. Therefore, the further apart from the center of the tab 922 in the tangential direction toward both sides of the tangential direction, the wider the gap between the wall section 912 and the tab 922 becomes. In this embodiment, the claw sections 42 are inserted into this gap from both sides in the tangential direction. By this, preparation for holding the tab 922 in the next step can be smoothly performed.

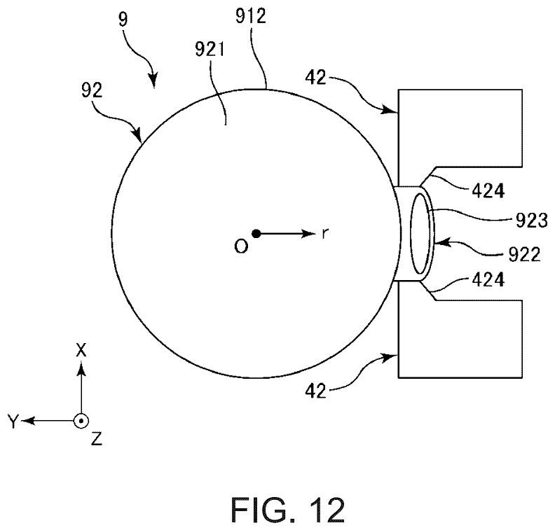

The claw sections 42 have the aforementioned inclined surfaces 424. As described above, these inclined surfaces 424 include the claw tip end sections 422 as one of the vertices, and forms a substantially triangular surfaces that are inclined with respect to both the X-axis and the Y-axis. Specifically, as viewed from the Z-axis, as shown in FIG. 11, the angle θ that is formed between the tangential direction and the inclined surface 424 is an acute angle (greater than 0° and less than) 90°, desirably between 10° and 60°, more desirably between 20° and 45°. In other words, the width W in the radial direction r of the claw section 42 has a shape that gradually increases from the claw tip end section 422 toward the base end section 423. Therefore, if the claw tip end section 422 continues to be inserted into the gap between the wall section 912 and the tab 922, the inclined surface 424 comes into contact with the tab 922, and the tab 922 slides along the inclined surface 424. By this, the distance between the wall section 912 and the tab 922 can be smoothly increased. As a result, as shown in FIG. 12, the gap between the wall section 912 and the tab 922 is more widely secured. Even if the tab 922 is disposed along the wall section 912, the preparation for holding the tab 922 in the next step can be performed in a shorter time in this step, so that the opening lid operation can be sped up.

Note that after the inclined surface 424 and the tab 922 came into contact with each other as described above, in some cases, the upper surface 425a shown in FIG. 6 and the tab 922 come into contact with each other to push up the tab 922, so that the distance between the wall section 912 and the tab 922 can be further increased.

### 1.5.2. Tab Holding Step

In the tab holding step S104, the hook 43 (tab holding section) holds the tab 922. Specifically, the tab 922 is held by the following procedure.

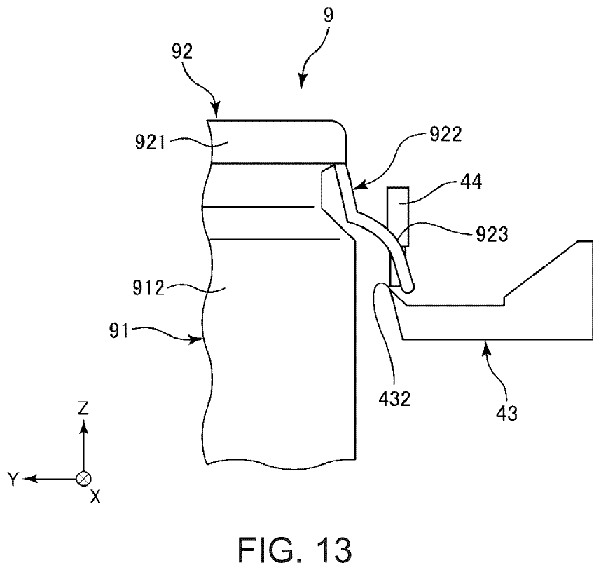

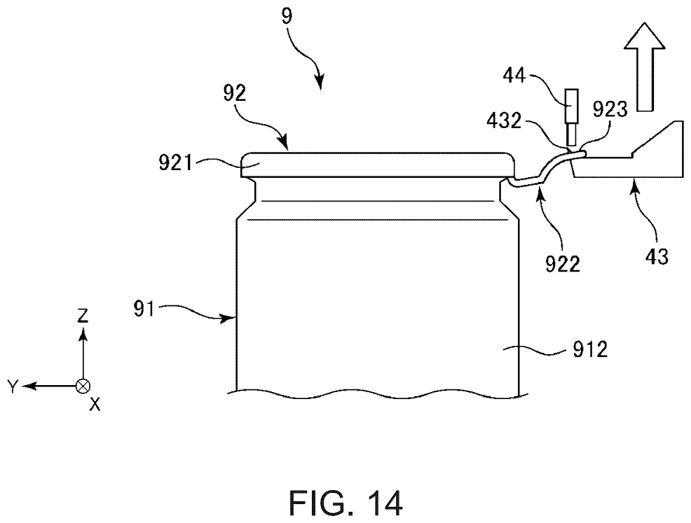

FIGS. 13 and 14 are schematic diagrams showing the positional relationship between the hook 43 and the tab 922 in the tab holding step S104. Note that in FIGS. 13 and 14, for convenience of illustration, only some of the elements constituting the tabbed lid opening hand 4 are shown.

In the tabbed lid opening hand 4 shown in FIG. 5, the hook 43 is located below the intermediate point between the claw sections 42. In other words, the hook 43 stays below the gap that is widened by the claw sections 42. When the tab 922 has the through hole 923, the hook 43 stays below the through hole 923 as shown in FIG. 13.

Then, the hand control section 74 operates the disengagement prevention drive section 49 to displace the disengagement prevention section 44 downward. By this, as shown in FIG. 13, the disengagement prevention section 44 contacts and approaches the upper surface of the hook 43. As a result, as shown in FIG. 13, the disengagement prevention section 44 is inserted into the through hole 923. By this, the tip end section 432 of the hook 43 and the disengagement prevention section 44 are continuously or intermittently connected. Therefore, it is possible to prevent the hook 43 from unintentionally slipping out of the through hole 923 (the tab 922 falling off from the hook 43). By this, the hook 43 securely holds the tab 922.

Note that in the case where the disengagement prevention section 44 is omitted, when the tabbed lid opening hand 4 is moved upward by controlling the posture of the robot arm 22, the upper surface of the hook 43 comes into contact with the tab 922. By this, the upper surface of the hook 43 is engaged with the tab 922. In the case where the tab 922 has the through hole 923, when the hook 43 is further moved upward from the state shown in FIG. 13, the tip end section 432 of the hook 43 is inserted into the through hole 923 as shown in FIG. 14. By this, the hook 43 can hold the tab 922.

Note that the form of holding is not limited to this. For example, in the case where the tab 922 does not have the through hole 923, the hook 43 may have a function of sandwiching the tab 922. Thereafter, the claw opening and closing section 46 is operated to separate the two claw sections 42, 42 from each other.

### 1.5.3. Removal Step

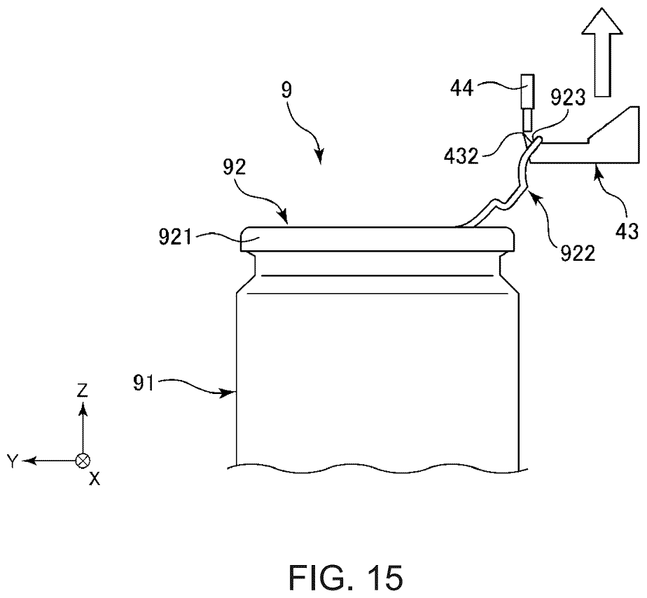

FIGS. 15 to 18 are schematic views showing the positional relationship between the hook 43 and the tab 922 in the removal step S106. Note that in FIGS. 15 to 18, for convenience of illustration, only some of the elements constituting the tabbed lid opening hand 4 are shown.

In the removal step S106, by the robot control section 71 changing the posture of the robot arm 22, the hook 43 (tab holding section), which is holding the tab 922, is moved relatively with respect to the container 91. By this, the tabbed lid 92 is removed from the container 91.

Specifically, first, as shown in FIG. 15, the hook 43, which is holding the tab 922, is pulled up higher than the lid main body 921. By this, as shown in FIG. 15, the top plate and the outer edge portion of the lid main body 921 start to fracture.

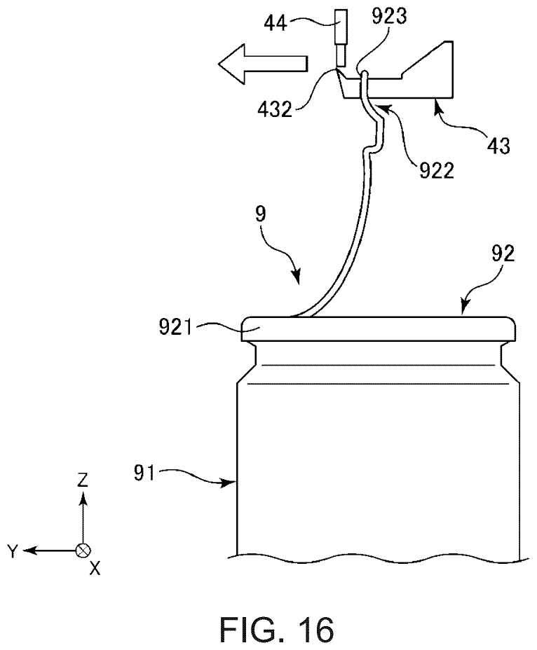

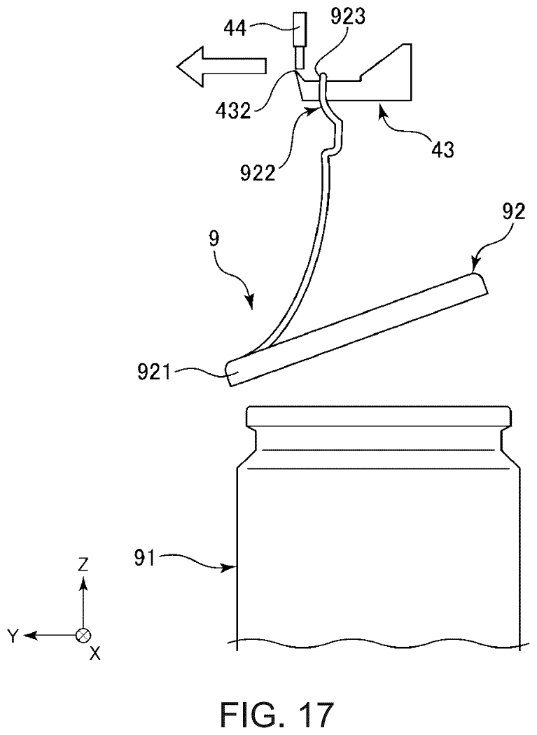

Next, as shown in FIG. 16, the hook 43, which is holding the tab 922, is moved to the Y-axis plus side. By this, the fracture between the top plate and the outer edge portion extends over the whole area and the outer edge portion loosens, then the tabbed lid 92 separates from the container 91 as shown in FIG. 17.

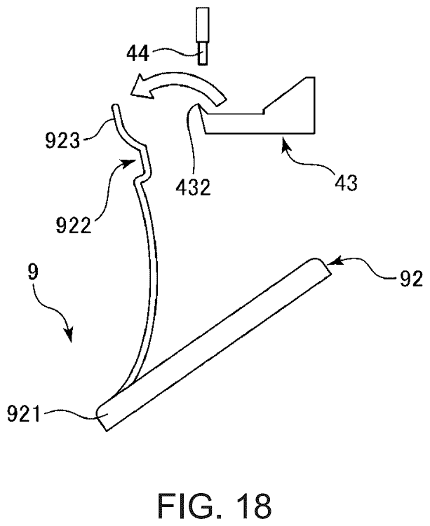

Next, as shown in FIG. 18, the hand control section 74 operates the disengagement prevention drive section 49 to displace the disengagement prevention section 44 upward. By this, the disengagement prevention section 44 is separated from the upper surface of the hook 43. As a result, as shown in FIG. 18, the tab 922 can be disengaged from the hook 43. At this time, by changing the posture of the robot arm 22 as necessary, the tabbed lid 92 may be swung to allow the tab 922 to be easily disengaged from the hook 43. As described above, the opening lid operation is completed. According to this method of opening a tabbed lid, the opening lid operation of the tabbed lid 92 can be automated. Therefore, labor saving and manpower saving of the opening lid operation can be achieved.

Further, if the robot arm 22 is capable of performing at least translational movement in the Z-axis and Y-axis direction, the opening lid operation can be performed by using the above described tabbed lid opening hand 4. In other words, by using the tabbed lid opening hand 4, even a robot arm that cannot perform pivotal motions around the X-axis, the Y-axis, and the Z-axis can be applied to the opening lid operation. By this, even the robot arm 22 with a small number of joints can be used in the tabbed lid opening system 1. As a result, it can easily simplify and lower the cost of the tabbed lid opening system 1.

### 2. First Modification Example of First Embodiment

Next, a tabbed lid opening hand 4 according to a first modification example of the first embodiment is described.

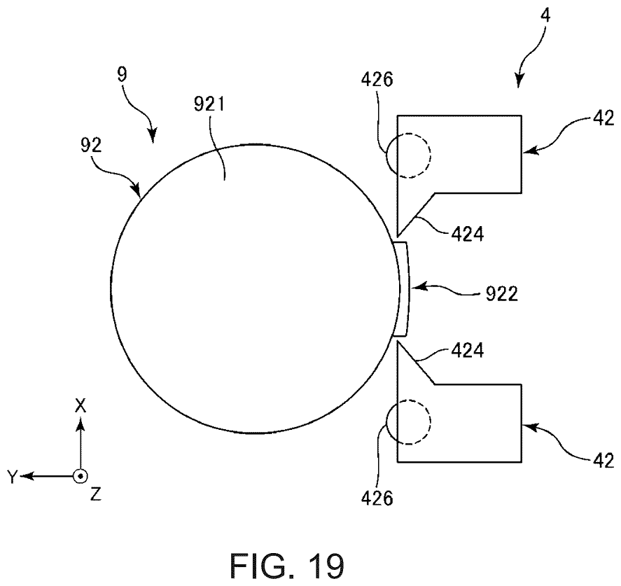

FIG. 19 is a schematic view showing the tabbed lid opening hand 4 according to the first modification example of the first embodiment. Note that in FIG. 19, for convenience of illustration, only some of the elements constituting the tabbed lid opening hand 4 are shown.

Hereinafter, the first modification example will be described. In the following description, differences from the first embodiment will be mainly described, and description of the same matters will be omitted. In FIG. 19, the same components as those of the first embodiment are denoted by the same reference numerals.

The tabbed lid opening hand 4 according to the first modification example is the same as the tabbed lid opening hand 4 of the first embodiment except that the configurations of the claw sections 42 are different.

The claw sections 42 shown in FIG. 19 have cam followers 426 (rotation body) that are provided on the surfaces facing the lidded container 9. The cam followers 426 are bearings with shafts having rotation axes parallel to the central axis AX2 of the container 91. Since the cam followers 426 have the outer rings that rotate smoothly, even if the outer rings and the container 91 come into contact with each other when the claw sections 42 are opening and closing, the load applied to the container 91 can be reduced. By this, it is possible to suppress the occurrence of damage or the like to the container 91.

Note that, instead of the cam followers 426 or in addition to the cam followers 426, the claw sections 42 may have members that reduce frictional resistance between the claw sections 42 and the container 91. Examples of such members include a felt, a fluoroplastic, and the like.

### 3. Second Modification Example of First Embodiment

Next, a method of opening a tabbed lid according to a second modification example of the first embodiment will be described.

In the method of opening a tabbed lid according to the

first embodiment described above, as shown in FIGS. 10 to 18, the lidded container 9 is fixed, and the tabbed lid opening hand 4 is moved by the robot arm 22 to perform the opening lid operation.

On the other hand, in the method of opening the tabbed lid according to the second modification example, a gripping section (not shown) for gripping the lidded container 9 is attached to the robot arm 22. The tabbed lid opening hand 4 is fixed. Then, the robot arm 22 moves the lidded container 9, not the tabbed lid opening hand 4, so as to follow the relative movement line of the tabbed lid opening hand 4 with respect to the lidded container 9. Even in such a method, since the robot arm 22 moves the hook 43 (tab holding section) relative with respect to the container 91, the same opening lid operation can be performed as in the above described embodiment. In each of the modification examples described above, the same effects as those of the first embodiment can be obtained.

### 4. Second Embodiment

Next, a method of opening a tabbed lid according to a second embodiment will be described.

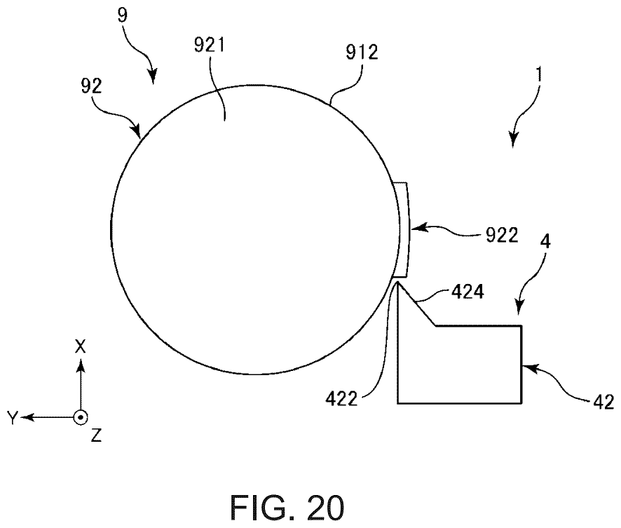

FIGS. 20 to 22 are schematic diagrams for explaining the method of opening a tabbed lid according to the second embodiment.

The second embodiment will be described below, but in the following description, the difference from the first embodiment will be mainly described, and the description of the same matters will be omitted. In FIGS. 20 to 22, the same components as those of the first embodiment are denoted by the same reference numerals.

The method of opening a tabbed lid according to the second embodiment is the same as the method of opening a tabbed lid according to the first embodiment except that the configuration of automatic machine to be used is different.

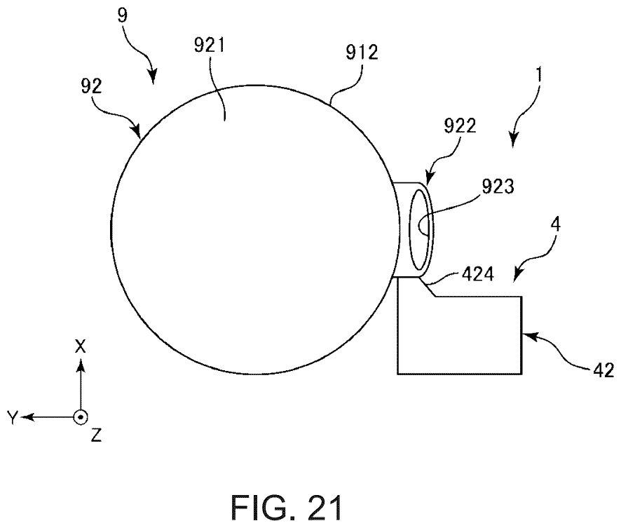

In the claw section insertion step S102 of the second embodiment, as shown in FIG. 20, a tabbed lid opening hand 4 having one claw section 42 is used. The claw opening and closing section 46 is operated and, as shown in FIG. 21, the claw tip end section 422 of the claw section 42 is made to enter the gap between the wall section 912 and the tab 922. By sliding the tab 922 along the inclined surface 424, the distance between the wall section 912 and the tab 922 can be increased.

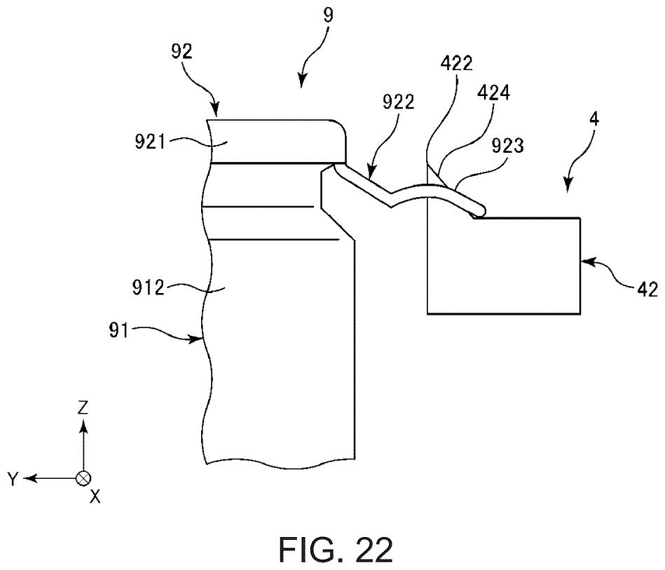

In the tab holding step S104 of the second embodiment, the claw section 42 shown in FIG. 22 also functions as the “tab holding section”. The claw section 42 shown in FIG. 21 can pivot around the Y-axis. Therefore, when the claw section 42 is rotated by 90° around the Y-axis from the state shown in FIG. 21, the claw tip end section 422 can be facing upward (Z-axis plus direction). By this, the claw tip end section 422 of the claw section 42 can be inserted into the through hole 923 of the tab 922. As a result, the tab 922 can be held by the claw section 42 (tab holding section).

In the removal step S106 of the second embodiment, the claw section 42 holding the tab 922 is moved relative with respect to the container 91 by changing the posture of the robot arm 22 from the state shown in FIG. 22. By this, the tabbed lid 92 is removed from the container 91. Also in the second embodiment as described above, the same effects as those of the first embodiment can be obtained.

### 5. Third Embodiment

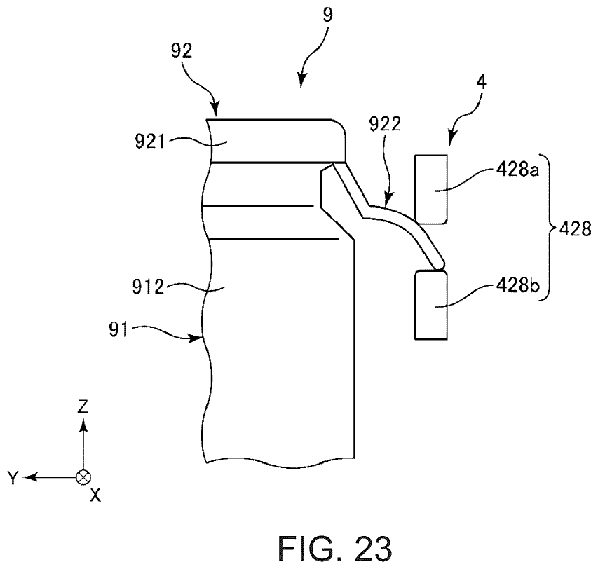

Next, a method of opening the tabbed lid according to a third embodiment will be described. FIG. 23 is a schematic view for explaining a method of opening a tabbed lid according to a third embodiment.

Hereinafter, the third embodiment will be described. In the following description, mainly described differences from the first embodiment, the description of the same matters will be omitted. In FIG. 23, the same components as those of the first embodiment are denoted by the same reference numerals.

The method of opening a tabbed lid according to the third embodiment is the same as the method of opening a tabbed lid according to the first embodiment except that the configuration of automatic machine to be used is different.

In the claw section insertion step S102 of the third embodiment, for example, similar to the claw section insertion step S102 of the first embodiment or the second embodiment, the distance between the wall section 912 and the tab 922 can be increased.

In the tab holding step S104 of the third embodiment, the tabbed lid opening hand 4 provided with the gripping section 428 shown in FIG. 23 is used. The gripping section 428 shown in FIG. 23 has two portions 428a and 428b arranged along the Z-axis. The portion 428a and the portion 428b sandwich the tab 922. The portions 428a and 428b are driven by an actuator (not shown) so that they can come into contact with or separate from each other. Therefore, the gripping section 428 functions as the “tab holding section”. According to this gripping section 428, the tab 922 can be held even when the tab 922 does not have the through hole 923. Note that a shape of the gripping section 428 is not particularly limited.

In the removal step S106 of the third embodiment, by changing the posture of the robot arm 22 from the state shown in FIG. 23, the gripping section 428 that is holding the tab 922 is moved relative with respect to the container 91. By this, the tabbed lid 92 is removed from the container 91. Also in the third embodiment as described above, the same effects as in the first embodiment can be obtained.

### 6. Effects of the Above Embodiments

As described above, the tabbed lid opening hand 4 according to the above described embodiments is used for the opening lid operation of removing the tabbed lid 92 from the opening section 913, and the tabbed lid 92 has the lid main body 921 that closes the circular shaped opening section 913 of the container 91 and the tab 922 that is connected to the lid main body 921 and that is provided along the outer side surface of the container 91. This tabbed lid opening hand 4 has the base section 41, two claw sections 42, 42, and the hook 43. The base section 41 is attached to the robot arm 22. Two claw sections 42, 42 are supported by the base section 41 and approach and separate from each other. The hook 43 is disposed so that its tip end section faces in the intersecting direction (intersecting axis direction), which intersects the approaching and separating directions (opening and closing axis directions), and is engageable with the tab 922.

According to this configuration, even when the tab 922 is disposed along the outer surface of the wall section 912 of the container 91, the tabbed lid opening hand 4, which enables the opening lid operation of the tabbed lid 92 to be automated, can be realized. By this, labor saving and manpower saving of the opening lid operation can be achieved.

In the tabbed lid opening hand 4 according to the above embodiments, the claw section 42 has a claw tip end section 422 and a base end section 423. The width W of the claw section 42 in the radial direction r of the opening section 913 gradually increases from the claw tip end section 422 toward the base end section 423.

According to this configuration, when the claw tip end section 422 continues to be inserted into the gap between the wall section 912 and the tab 922, the distance between the wall section 912 and the tab 922 can be smoothly increased by the above described shape of the claw section 42. As a result, even when the tab 922 is disposed along the wall section 912, the preparation for holding the tab 922 can be performed in a short time, and thus the opening lid operation can be speeded up.

The tabbed lid opening hand 4 according to the above embodiments has the pressing section 45. The pressing section 45 is supported by the base section 41 and is pressed against the lid main body 921.

According to this configuration, the distance between the tabbed lid opening hand 4 and the lidded container 9 can be set to a target distance. Since it is possible to avoid contact with the container 91 by pressing the pressing section 45 against the lid main body 921, it is possible to prevent the container 91 from being damaged or the like.

The tabbed lid opening hand 4 according to the above embodiments has the slide section 48. The slide section 48 enables the claw section 42 to move with respect to the base section 41.

According to this configuration, the excessive pressing force exerted by the tabbed lid opening hand 4 on the lidded container 9 can be suppressed. As a result, it is possible to suppress the container 91 from being damaged or the like.

The tabbed lid opening hand 4 according to the above embodiments has the disengagement prevention section 44. The disengagement prevention section 44 is supported by the base section 41 and approaches and separates from the hook 43.

According to this configuration, since the hook 43 and the disengagement prevention section 44 are continuously or intermittently connected to each other, for example, in a case where the tab 922 has the through hole 923, it is possible to prevent the hook 43, which is inserted into the through hole 923, from unintentionally slipping off (the tab 922 falling off from the hook 43). By this, the hook 43 securely holds the tab 922.

The tabbed lid opening hand 4 according to the above embodiments have the disengagement prevention drive section 49. The disengagement prevention drive section 49 drives the disengagement prevention section 44 to approach and separate from the hook 43. According to this configuration, the disengagement prevention section 44 can be driven at a desired timing.

In the tabbed lid opening hand 4 according to the above embodiments, the claw sections 42 have the cam followers 426 (rotation bodies) having rotation axes parallel to the central axis AX2 of the container 91.

According to this configuration, since the cam followers 426 smoothly rotate, it is possible to reduce a load applied to the container 91 even when the cam followers 426 and the container 91 come into contact with each other when the claw sections 42 are opened and closed. By this, it is possible to suppress the occurrence of damage or the like to the container 91.

The tabbed lid opening hand 4 according to the above embodiments has the claw opening and closing section 46. The claw opening and closing section 46 drives the claw sections 42 to open and close. According to this configuration, the claw sections 42 can be driven at a desired timing.

The tabbed lid opening system 1 according to the above embodiments includes the robot 2 and the tabbed lid opening hand 4 according to the above embodiments. The robot 2 is equipped with the robot arm 22. The tabbed lid opening hand 4 is attached to the robot arm 22.

According to this configuration, it is possible to realize the tabbed lid opening system 1 that enables the opening lid operation of the tabbed lid 92 to be automated, even when the tab 922 is disposed along the outer side surface of the wall section 912 of the container 91.

The method of opening a tabbed lid according to the above embodiments is a method of removing the tabbed lid 92, which has the lid main body 921 that closes a circular shaped opening section 913 of the container 91 and the tab 922 that is connected to the lid main body 921 and that is provided along the outer side surface of the container 91, from the opening section 913 by the automatic machine.

The automatic machine has the claw section 42, the hook 43 (tab holding section), and the robot arm 22. The robot arm 22 moves the hook 43 relative with respect to the container 91.

The method of opening a tabbed lid according to the above embodiments has the claw section insertion step S102, the tab holding step S104, and the removal step S106. In the claw section insertion step S102, assuming that the direction parallel to the tangential line of the outer edge of the opening section 913 is the tangential direction, the distance between the container 91 and the tab 922 is increased by inserting the claw section 42 between the container 91 and the tab 922 along the tangential direction. In the tab holding step S104, the hook 43 (tab holding section) holds the tab 922. In the removal step S106, the robot arm 22 removes the tabbed lid 92 from container 91 by moving the hook 43, which is holding tab 922, relative with respect to the container 91.

According to this configuration, even when the tab 922 is disposed along the outer side surface of the wall section 912 of the container 91, the opening lid operation of the tabbed lid 92 can be performed using the automatic machine. By this, labor saving and manpower saving of the opening lid operation can be achieved.

The tabbed lid opening hand, the tabbed lid opening system, and the method of opening a tabbed lid in the present disclosure have been described based on the illustrated embodiments. However, the present disclosure is not limited to these.

For example, the tabbed lid opening hand and the tabbed lid opening system according to the present disclosure may be obtained by replacing each section of the above described embodiments with an arbitrary component having the same function, may be obtained by adding an arbitrary component to the above described embodiments, or may be obtained by combining the above described embodiments.

In addition, the method of opening a tabbed lid according to the present disclosure may be a method in which a step for an arbitrary purpose is added to the above embodiments.

What is claimed is:

1. A tabbed lid opening hand for use in an opening lid operation for removing a tabbed lid, which has a lid main body that closes a circular shaped opening section of a container and a tab that is connected to the lid main body and that is disposed along the outer side surface of the container, from the opening section, the tabbed lid opening hand comprising:
a base section that is attached to a robot arm;
two claw sections that are supported by the base section and that approach and separate from each other; and
a hook that is disposed with its tip end section facing in a direction intersecting the approach and separation directions and that is configured to engage with the tab.

2. The tabbed lid opening hand according to claim 1, wherein
the claw sections have claw tip end sections and base end sections and
a width of the claw sections in a radial direction of the opening section gradually increases from the claw tip end sections toward the base end sections.

3. The tabbed lid opening hand according to claim 1, further comprising:
a pressing section that is supported by the base section and that is pressed against the lid main body.

4. The tabbed lid opening hand according to claim 3, further comprising:
a slide section that is configured to move the claw sections with respect to the base section.

5. The tabbed lid opening hand according to claim 1, further comprising:
a disengagement prevention section that is supported by the base section and that is configured to approach and separate from the hook.

6. The tabbed lid opening hand according to claim 5, further comprising:
a disengagement prevention drive section that drives the disengagement prevention section so that it approaches and separates from the hook.

7. The tabbed lid opening hand according to claim 1, wherein
the claw sections have rotation bodies having rotation axes that are parallel to a central axis of the container.

8. The tabbed lid opening hand according to claim 1, further comprising:
a claw opening and closing section that drives the claw sections to open and close.

9. A tabbed lid opening system, comprising:
a robot with a robot arm, and
a tabbed lid opening hand according to claim 1, which is attached to the robot arm.

10. A method of removing a tabbed lid, which has a lid main body that closes a circular shaped opening section of a container and a tab that is connected to the lid main body and that is disposed along an outer side surface of the container, from the opening section by an automatic machine, the automatic machine having a claw section, a tab holding section, and a robot arm that moves the tab holding section relative to the container, the method of opening the tabbed lid comprising:
extending a distance between the container and the tab by inserting the claw section between the container and the tab along a tangential direction, assuming that the tangential direction is a direction parallel to a tangential line of the outer edge of the opening section;
holding the tab by the tab holding section; and
removing the tabbed lid from the container by the robot arm by moving the tab holding section, which is holding the tab, relative to the container.
